(19) United States
(12) Patent Application Publication
(10) Pub. No.: US 2006/0169641 A1
(43) Pub. Date: Aug. 3, 2006

(54) Water softening method and system

(75) Inventors: Dan A. Duke, Temecula, CA (US); John L. Kubis, Mission Viejo, CA (US)

Correspondence Address: STETINA BRUNDA GARRED & BRUCKER, 75 ENTERPRISE, SUITE 250, ALISO VIEJO, CA, 92656, US

(73) Assignee: Water Enviro Tech Company, Inc.

(21) Appl. No.: 11/046,064

(22) Filed: Jan. 28, 2005

(51) Int. Cl. C02F 1/42

(52) U.S. Cl. 210/670

(57) ABSTRACT

The present invention generally relates to systems and methods for the removal of hardness ions, namely calcium and magnesium, from water. Water is efficiently softened in a manner which limits the volume amount of undesirable waste that is sent to municipality or other waste treatment systems by utilizing an ion exchange resin that is capable of being regenerated for repeated use. The present invention also includes a water softening apparatus and method useable for commercial and industrial water softening applications that reuses and recycles sodium from heat transfer surface evaporative systems which further reduces regenerant usage and wastage.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention generally relates to the systemic removal of certain mineral cationic elements, and in particular calcium and magnesium ions, from water utilized in heat transfer process applications. More particularly, the present invention is directed to a method for efficiently softening water containing certain cations in a manner which limits the volume amount of undesirable waste that is sent to municipality and other waste treatment systems.

“Hard” water is water which contains dissolved mineral ions, particularly calcium or magnesium ions. Hard water can present a considerable problem in reducing the efficiency of boilers, heating systems, heat transfer surface cooling systems and other apparatus, and in certain industrial process use. Accordingly, it is often desirable to provide a means for removing the unwanted calcium or magnesium salts from the hard water, thereby to provide “soft” water which does not contain such ions. This process is known as “softening” water.

A common method of softening water, such as in conventional water softeners, involves the process of ion exchange. Ion exchange is a process whereby a water solution is passed through a column of a material that replaces one kind of ion in solution with another kind of like charge. Such materials are known as ion exchange resins. Commercial and industrial water softeners generally contain cation-exchange resins for displacing one cation for another. These resins consist of insoluble macromolecular or polymeric substances to which negatively charged functional groups are covalently bound. The negative charges are counterbalanced by soluble cations, such as sodium ions. When hard water containing the calcium or magnesium ion passes through a column of resin, the sodium ions ionically bound to the resin are replaced by calcium or magnesium ions. The reaction may be generalized as follows for calcium:

R₂Na₂+Ca⁺²→R₂Ca+2Na⁺ (aq) where R is an anionic functional group of the exchange resin. The reaction for magnesium (Mg²⁺) is similar to the reaction for calcium.

Water that has passed through the column containing the ion exchange resin exchanges sodium ions in place of the calcium and magnesium ions, and this has been softened. Once the resin has been completely converted to a calcium and/or magnesium salt, it can be regenerated by flushing the column with a concentrated solution of sodium chloride to reverse the previous reaction.

To perform this process in commercial and industrial use, water softeners generally consist of a resin vessel filled with softening resin, a riser tube that has a screened opening at the bottom of the resin vessel and that extends through a vessel inlet/valve outlet in the resin vessel and a multi-port valve that directs the flow of water through different channels to and from the resin vessel. In the service cycle, when water is being softened, the hard water would flow, through the multi-port valve and into the resin vessel from the outer diameter of the vessel inlet/valve outlet. The water would then go through the resin bed and become softened. The softened water then flows through the screened opening in the riser tube at the bottom of the, resin vessel, through the multi-port valve and to the intended water supply.

Once the resin has been completely converted to the calcium or magnesium salt, the resin must be regenerated. During regeneration, most softeners flow brine (which is formed by dissolving common rock salt in water) in the same direction as the service flow, and direct the water from the riser tube through the multi-port valve to a common drain, which is generally connected to a sewer. Some softeners may use a countercurrent flow of brine, but also direct all waste to the drain.

In commercial applications, the regeneration process generally includes several steps, including a backwash, brine injection, a slow rinse and a fast rinse. While there may be some slight variations in different water softeners (for example, the sequence of the steps or the direction of flow may be different for some configurations), most water softeners generally utilize the same regeneration principles. For example, in the backwash step water is directed down through the riser tube and flows upward in the resin vessel. This step lifts the resin bed and directs the waste through the outer diameter opening of the resin vessel, through the multi-port valve and to the drain.

The step of brine injection generally involves opening an inlet valve to an educator/injector. The educator/injector essentially comprises a venturi valve. The inlet valve is connected to a brine tank, such as with a flexible tube. Brine in the brine tank is formed by water and rock salt that a user puts in the brine tank periodically. Water is generally provided by a step in the regeneration process which directs water through the multi-port valve to the brine tank. The brine tank generally does not require any agitation, rather it simply saturates by soaking in the salt. The brine injection step includes sending city water at full pressure past the venturi valve, thereby causing a pressure gradient and sucking brine in from the injector to mix with the city water (or water from other water sources, such as well water) used to cause the pressure drop. This mixture is directed through the resin bed, up the riser tube, and out the common-drain. The cycle is timed to allow the resin exposure to a specific mass of sodium chloride, which is directly proportional to the capacity desired. Generally, the maximum salt required for achieving maximum resin regeneration capacity is exposed to the resin. After a specific amount: of time has elapsed, therefore, the brine inlet valve is closed.

During the slow rinse step, water from a given water source (such as a municipal or city water source) continues to be sent through the venturi valve. The venturi valve now acts as a flow control device and sends a slow stream of water to the resin bed, thereby rinsing the salt out. The waste is directed to a drain that ultimately passes to a municipal wastewater treatment facility. During the fast rinse step, tap water is allowed to flow at full flow through the resin bed and the water is then directed to the “city” drain. This step packs the resin bed as well as purges any remaining salt out of the resin vessel. During this cycle, most water softeners also open the brine valve and refill the brine tank. A miniature float check valve in the brine tank shuts off flow when the brine tank has reached its capacity.

The multi-port valves for use with such water softeners consist of various types. For example, Autotrol, a division of Osmonics, located in Minnetonka, Minn., uses flapper valves; Fleck Valves, located in Brookfield, Wis., uses a moving piston with openings at different points, and Erie Valves, located in Milwaukee, Wis., uses a revolving disk with openings at different points, the construction of each being well-known in the art and incorporated herein by reference.

Exemplary of the prior art related to water softening techniques and ion-exchange regeneration systems are set forth in the following issued U.S. patents: U.S. Pat. No. 5,718,828, issued to Jangbarwala, et al. on Feb. 17, 1998; U.S. Pat. No. 6,776,913, issued to Jangbarwala on Aug. 17, 2004 entitled WATER SOFTENING METHOD AND APPARATUS FOR USE THEREWITH; and U.S. Pat. No. 5,951,874, issued to Jangbarwala, et al. on Sep. 14, 1999 entitled METHOD FOR MINIMIZING WASTE WATER DISCHARGE. The teachings of all such patents are expressly incorporated herein by reference.

Despite their utility, self-regenerating water softeners have the drawback of sending the waste down the drain to municipality or other waste treatment systems, where excessive salt levels in the water may prevent reuse of the waste water for irrigation and other use. Because of such wasteful and inefficient procedures, there is increasing pressure from municipalities and other reuse authorities to ban self-regenerating water softeners. Indeed, several major areas where water is becoming scarce already do not allow these devices. For example, Irvine, San Diego, San Bernardino and Riverside Counties in California do not allow the use of self-regenerating water softeners. Further, as of 1999 legislation has been introduced in the California Assembly to ban such devices altogether in California. In other parts of the country where water is scarce, the use of such self-regenerating water softeners may likewise be at risk.

Accordingly, the water softener industry has been aggressively attempting to improve the efficiency of the devices they manufacture. Devices currently on the market, however, do not reduce the volume of water and regenerate wastage sufficiently enough to make softening environmentally and economically attractive, as compared to other water conservation alternatives. Accordingly, there is a substantial need for a new method for softening water with an ion exchange system that will provide a drastic reduction in waste volume, particularly when used in connection with heat transfer process applications, such as cooling tower and boiler applications. Further, there remains a need for a new water softening and regenerate saving process that reduces the waste volume sent to municipality waste treatment systems, and which allows the salt waste to be discharged or to be economically disposed of through alternative disposal routes. The present invention is directed to meeting these needs.

### BRIEF SUMMARY OF THE INVENTION

The present invention provides methods and systems that address the aforementioned deficiencies in the art. Specifically, there is provided a water softening system and method that are adapted to be utilized in connection with an industrial heat-transfer process application, which may include an evaporative process or a specific type of cooling tower/boiler application, such that the softened water fed to such heat-transfer process device or application is ultimately collected following its use in the application and thereafter utilized to facilitate regeneration of a portion of an ion exchange resin utilized to generate softened water. In its simplest arrangement, the system and method of the present invention utilize the following elements: 1) a primary water softening apparatus operative to receive water from a water source containing hardness ions; 2) a secondary water softening apparatus operative to receive softened water from the primary water softening apparatus; 3) a process application (e.g., cooling tower/boiler, industrial processes and the like) operative to receive softened water from both the primary. and secondary water softening apparatuses; 4) a recycled/recovered regenerant reservoir for receiving water recovered from the process application that is operative to transfer such water to the primary water softening apparatus. The system further includes a separate regenerant solution reservoir for holding a brine solution operative to regenerate the primary water softening apparatus. The secondary water softening apparatus will likewise have a regenerant solution reservoir for holding brine for such purpose. A drain will further be provided that is fluidly connected to, the primary and secondary water softening apparatuses for use in ultimately disposing of cationic solutions that may be disposed of through municipal treatment means or isolated treatment means pursuant to well-known techniques in the art.

The primary apparatus comprises an ion exchange resin vessel containing an ion-exchange resin that is capable of chemically shifting between an active state, wherein the resin exchanges sodium ions for hardness ions, and an exhausted state, wherein hardness ions saturate the resin. The ion-exchange resin may be a shallow shell/shortened diffusion path resin or small bead size resin, and is preferably a Purolite SST or Purolite C100FM resin.

Fluidly coupled to the primary softening apparatus is a dedicated regenerant solution reservoir operative to hold and infuse into the primary ion exchange resin vessel concentrated brine solution operative to “regenerate” the ion exchange resin housed therein, namely, displace the hardness ions with sodium ions via conventional practices.

A secondary water softening apparatus is fluidly coupled to the primary water softening, apparatus and is operative to receive softened water therefrom. The secondary softening apparatus, like the primary water softening apparatus, consists of an ion exchange vessel for housing a resin, the latter being operative to displace hardness ions with sodium ions. The second ion exchange vessel will further have a dedicated regenerant solution reservoir fluidly coupled thereto to facilitate the regeneration of the ion exchange resin whereby hardness ions will be displaced with sodium ions provided by the brine held within the reservoir, per conventional practice. In a preferred embodiment, the secondary or polishing water softening apparatus also comprises a continuous recirculation pump to provide approximately 10% return of design service flow output to the influent inlet of the polisher apparatus. The ion-exchange resin may be a shallow shell/shortened diffusion path resin or small bead size resin, and is preferably a Purolite SST or Purolite C100FM resin.

Fluidly connected to both the primary and secondary water softening apparatuses is at least one process application or device that is operative to receive water softened by one or both of the primary or secondary softening apparatuses and thereafter utilize the same in an industrial process that preferably includes a heat-transfer event. Specifically, it is contemplated that the process application or process device will involve an evaporative process and may expressly comprise a cooling tower or boiler application whereby the softened water is utilized to facilitate the transfer of heat.

A recycled/recovered regenerant reservoir is provided that is operative to receive and hold the water that is spent from the process application. In this regard, the recycled regenerant reservoir will receive all or a portion of the solution utilized in the process application for transferring heat. By virtue of having been utilized in connection with a heat-transfer process, a portion of the water originally fed to the process application will have evaporated, thus producing a sodium rich solution that will typically comprise approximately 2-3 percent sodium.

The sodium rich solution housed within the recycled/recovered regenerant reservoir may then be fed to the primary water softening apparatus for use in displacing a portion of the hardness ions contained by the resin. Although not as optimal as if regenerating the ion exchange resin housed within the primary water softening apparatus via the use of an approximate 10 percent brine solution, as utilized in conventional regeneration practices, the partial regeneration using the sodium rich recycled/recovered regenerant solution will nonetheless displace a significant portion of the hardness ions, which in turn advantageously provides substantial water conservation and further drastically minimizes the amount of rock salt/brine solution that typically must be generated in order to recondition ion exchange resins for use in further water softening applications.

In an alternative embodiment, it is contemplated that the recycled/recovered regenerant reservoir may also be maintained in fluid communication with the regenerant solution reservoir containing the conventional brine solution utilized to fully regenerate the ion exchange resin housed within the primary water softening apparatus. It is likewise contemplated that in some embodiments that either the recycled/recovered regenerant reservoir and/or the regenerant solution reservoir will have separate inputs through which additional water, salt and/or chemical modifying agents, such as acids or bases for modifying pH, may also be provided.

In order to ultimately dispose of the cationic minerals ultimately accumulated by virtue of the water softening processes of the present invention, it is contemplated that a drain will be coupled to the primary and secondary water softening apparatuses, per conventional water softening applications, that preferably will allow for waste solutions to be disposed of through municipal treatment means and/or through conventional disposal/treatment mechanisms well-known in the art.

The present invention is further directed to methods for softening water that contains undesired ions. The method preferably comprises providing a first ion-exchange resin, contacting the ion-exchange resin with water that contains undesired hardness ions when the ion-exchange resin is shifted toward its active state, and transferring the softened water to a second ion exchange resin, which is also shifted towards its active state, or to a process application which involves a heat-transfer/evaporative process. To the extent water is contacted to the second ion-exchange resin, the resultant water having undergone further softening is then forwarded to the process application. The water forwarded to the process application is then utilized for its intended heat-transfer application and thereafter collected to form the regenerant solution. The process then involves contacting the primary ion-exchange resin with the regenerant solution, which will contain preferred sodium ions, when the ion-exchange resin is shifted toward its exhausted state so as to form a waste solution containing the undesired ions, and either discharging to a municipal drainage line or collecting the waste solution thereby to permit selective disposal of the undesired ions via a processing alternative that is separate from a drainage line. The method will further integrate periodically contacting the first ion-exchange resin with a brine regenerant solution, per conventional ion-exchange resin regeneration practices, to supplement the regeneration process effectuated by contacting the first ion-exchange resin with the regenerant solution accumulated from the process application step.

In certain applications, the method may further include a pH reduction step whereby the pH of the brine regenerant solution (brine source) in the brine regenerant reservoir is reduced by addition of acid such as hydrochloric, citric or sulfamic acid. The reduced pH regenerant source solution may be used accordingly in the regeneration step with or without addition of brine (salt) to the solution. Selective ion removal (cation and anion exchange) of make-up to the regenerant reservoir may also be employed to reduce pH to the desired level, and is the preferred embodiment of this step. This step may be used following the step of regeneration with recycled/recovered regenerant solution to aid removal of insoluble precipitates that may form on the resin during contact with the recycled/recovered regenerant.

The method may further include the step of rinsing the ion-exchange resin with water thereby to form a rinse solution and thereafter transporting the rinse solution to a heat transfer surface evaporative system, thereby conserving water and regenerant for reuse/recovery. This step may also be eliminated with return to normal service flow, and consumption of softened water in the heat transfer surface evaporative system.

### BRIEF DESCRIPTION OF THE DRAWINGS

These and other objects of the present invention will become more readily appreciated and understood from a consideration of the following detailed description of the exemplary embodiment of the present invention when taken together with the accompanying drawings, in which:

FIG. 1 is a schematic diagram depicting the components and flow of water exchanged therebetween for use in the practice of the systems and methods of the present invention.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present invention is directed to systems and methods for softening water which limits or reduces the amount of waste sent to municipality or other water treatment systems, preferably to reduce or eliminate high dissolved solids-bearing waste to such treatment systems. In particular, the present invention utilizes ion exchange resins with very fast kinetics and further utilizes recovered/recycled regenerant solution from a heat transfer surface evaporative system to reduce virgin salt regenerate use and wastage, and conserve water wastage. The present invention provides waste volume reduction steps that will enable the efficient separation of salt-bearing waste from the hardness ion waste with current well known methods, thereby to allow the potential reuse of the salt-bearing waste in softener regeneration and/or beneficial applications of the hardness ion waste, or for either to be separately disposed. In addition, the present invention allows the water used to rinse the resin (quality or final rinse) to be used for make-up to the heat transfer surface evaporative system, conserving the major source of water wastage in normal softener regeneration and further conserving the remaining regenerate sodium/salt rinsed from the resin in the recycled/recovered regenerant of the heat transfer process application.

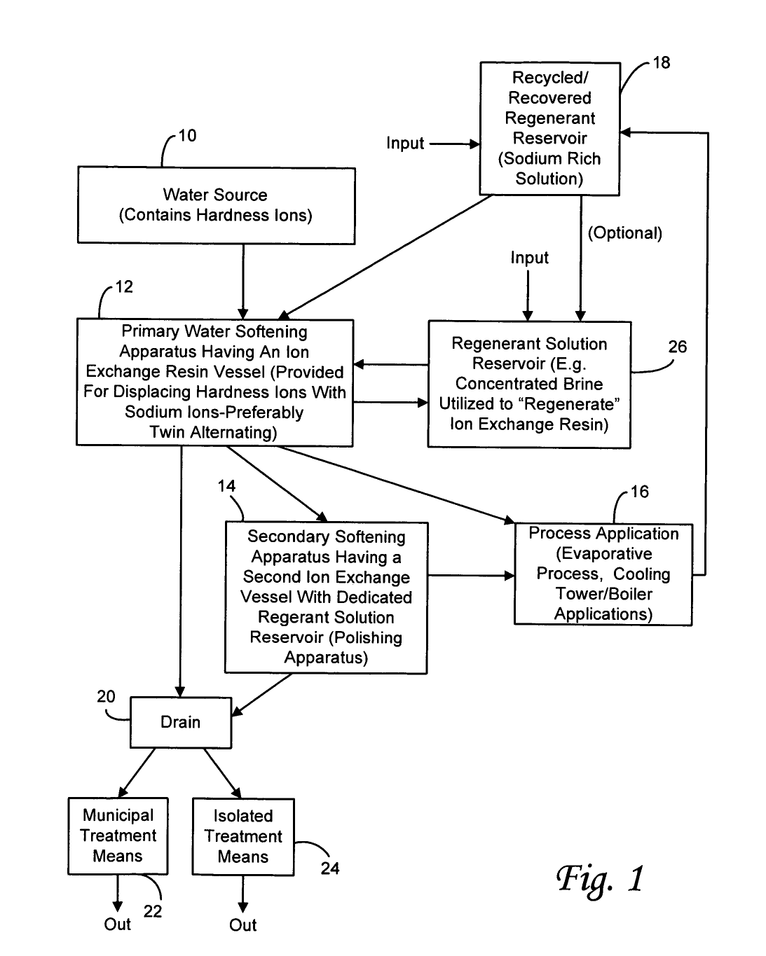

Referring now to FIG. 1, there is schematically illustrated the components comprising the system of the present invention, as well as the methodology by which the various pathways through which the flow of water interacts with such components to derive the benefits herein described. As illustrated, a water source 10 is provided containing hardness ions, namely, calcium and magnesium ions. Such water may be derived from a number of sources, and in particular municipal water sources and the like. It should be understood that water from other sources, such as well water or water internal to an industrial plant, may be used as the water source. Accordingly, for purposes of the present invention, water derived from the water source can encompass virtually any selected type of water source.

The water provided by the water source 10 is then introduced into a primary water softening apparatus 12, the latter having an ion exchange resin vessel housing a first ion-exchange resin, where the hardness ions are removed by ion exchange in techniques well-known to those skilled in the art. For purposes of the practice of the present invention, it is preferred that the ion exchange resin within apparatus 12 be a resin with very fast kinetics. Preferred resins include those manufactured by Purolite, located in Bala Cynwyd, Pa., including the Purolite SST resins and the Purolite C-100-FM. These Purolite resins are classified as “Fine Mesh” resins and have relatively small diameter bead sizes that may range from approximately 16 US mesh to 70 US mesh. The Purolite SST resins, such as the SST-60, have fast kinetics because the ion exchange region is only on the surface of the bead, rather than throughout the sphere of the bead. Such resins are known in the industry as Shallow Shell or Shortened Diffusion Path (SDP) resins. The Purolite C100FM has fast kinetics due to very small bead size. It should be understood that the present invention contemplates the use of ion exchange resins having both standard and very fast kinetics, as well as ion exchange resins which are similar or equivalent to the Purolite versions. It is also contemplated that the primary water softening apparatus will comprise a twin alternating vessels insofar as such arrangement will minimize potential service flow interruption during regeneration and minimize load and exhaustion of the secondary water softening system discussed below.

Once the hardness ions are removed by the primary water softening apparatus 12, the softened water can be directed to two applications. In the first, the softened water output is forwarded on to a secondary softening apparatus 14 comprising a secondary ion exchange resin vessel housing a second ion-exchange resin. The second ion-exchange resin will preferably take the same form as those discussed above with respect to the first ion-exchange resin. To allow for long term hardness-removal in certain industrial applications, in a preferred embodiment, the secondary or polishing water softening apparatus also comprises a continuous recirculation pump to provide approximately 10% return of design service flow output to the influent inlet of the polisher apparatus.

In the second alternative application, the softened water output from the primary apparatus 12 vessel, as well as the softened water from the secondary softening apparatus 14, may be forwarded on to a process application 16, which may comprise a variety of heat transfer or evaporative applications, such as those used for cooling towers or boilers. Along these lines, it is contemplated that the removal of the hardness ions will serve as the first step in rendering the water useful in heat transfer applications that advantageously avoid the buildup of scale and/or develop corrosion inhibition as taught in Applicant's co-pending patent application Ser. No. 10/754,797, entitled COOLING WATER SCALE AND CORROSION INHIBITION, filed Jan. 9, 2004 and Ser. No. 10/814,324, entitled COOLING WATER SCALE AND CORROSION INHIBITION, filed Mar. 31, 2004, the teachings of each of which are expressly incorporated herein by reference.

The system further includes a recycled/recovered regenerant solution reservoir 18 that is operative to receive the recycled/recovered water used from the process application 16. In this respect, it is contemplated that the softened water fed to the process application 16 will, by virtue of its exposure to heat transfer/evaporative processes, generate a sodium-rich solution created by virtue of the sodium ions introduced into the water by virtue of the water softening process followed by subsequent water loss through evaporation. Along these lines, it is contemplated that through conventional evaporative processes, such as through cooling tower/boiler applications, the recycled/recovered regenerant solution will generally include 2 to 3 percent sodium dissolved therein. The recycled/recovered regenerant reservoir including the recycled/recovered regenerant will be operatively coupled to the primary water softening apparatus 12, and more particularly the ion exchange resin vessel(s), which enables the recycled/recovered regenerant, to systematically regenerate the first ion exchange resin for repeated use in generating softened water, but advantageously enables such ion exchange resin to be regenerated in a manner that is far less wasteful and substantially more efficient than prior art practices.

To that end, the regeneration of the resin will include pumping a specific volume of the recycled/recovered regenerant from the reservoir 18 into the resin vessel, thereby pushing the service water that was in the resin vessel through a drain 20, which may go to a municipal treatment means 22, such as a municipality waste treatment system, or to an isolated treatment means 24 such as a waste storage and processing system. The recycled/recovered regenerant continues to be pumped into the primary water softening vessel to push the solution containing the regeneration waste dissolved solids from the first ion exchange resin, which contains the unused regenerate ions and hardness ions removed from the resin as dissolved solids that may be objectionable to the municipalities. This step may be followed by addition of normal brine regenerant provided by regenerant solution reservoir 26 fluidly coupled to the primary water softening apparatus 12 or by other regenerant solutions and a displacement rinse to remove waste solution containing hardness, which is directed to the municipality or waste storage and processing system.

Per conventional practices, the regenerant solution, such as brine solution, from the regenerant solution reservoir 26, or brine tank, connects to the resin vessel(s) of the primary water softener 12. The brine solution contacts the ion exchange resin in the resin vessel and exchanges sodium ions for the metal ions (calcium and magnesium) removed from the hard water during the softening process, thereby regenerating the ion exchange resin. It should be understood that appropriate regenerant solutions may be substituted for the brine solution for a given ion-exchange resin. Service water, which contains no or little regenerant wastes, is pushed out of the volume of the resin vessel while brine is being pushed into the resin vessel. This displaced service water is sent to the municipality waste treatment system or other disposal means. The brine refill cycle will send a specific volume of softened municipal or city water, equal to the volume of brine used, through the inlet, through the resin vessel, and to the brine tank, thereby to rinse the resin vessel as well as refill the brine tank. Preferably, the regeneration waste solution is sent to a brine recovery process or other waste treatment method, which allows the excess dissolved solids and salts remaining to be disposed of through alternative solids disposal routes.

Accordingly, it is contemplated that two regenerant sources can be utilized by using a conventional brine solution, on one hand, and by using the softened water utilized in the process application, on the other hand, insofar as the same will be devoid of hardness ions and ultimately posses a sufficient concentration of sodium by virtue of the water that will evaporate via the use of such water as part of a heat transfer application. In this respect, the evaporative process will cause the softened water to eventually evaporate to concentrate the sodium form that may ultimately be utilized as the input into the separate recycled/recovered regenerant solution reservoir 18. To provide added flexibility, it is contemplated that the normal brine regenerant solution reservoir 26 will include means to receive recycled/recovered regenerant solution, in addition to salt, and in some applications a pH modifying component (i.e., base or acid), as may be necessary or desired to modify and/or regenerate the ion exchange resin present in the ion exchange resin vessel. Indeed, it is expressly contemplated that two regenerant sources will exist between the primary ion exchange resin vessel to thus enable water utilized by the systems and methods of the present invention to conserve as much water and sodium ions as is realistically possible.

In this respect, and as is typical of the prior art, regenerant solutions of brine must not only be continuously generated, but unfortunately such solutions are continuously wasted during the regeneration of ion exchange resins which has the net effect of wasting tremendous volumes of water with the further requirement of continuously adding a source of sodium (rock salt) that ultimately becomes introduced into the environment. Advantageously, such wasteful practices are avoided via the practice of the present invention whereby previously softened water containing the preferred sodium ions is conserved and repeatedly utilized to facilitate regeneration of the ion-exchange resin. Even though less effective than the use of higher sodium strengths of brine, such recovered regenerant solution, even if only having 2-3% sodium ions, is believed to result in a decrease of approximately 60-80% of the salt (NaCl) and 60-80% of the water that would normally be utilized to regenerate the ion-exchange resin.

Likewise, it is contemplated that the polishing step or second water softening process, will also operate in a similar manner whereby such polishing step will produce an output that can be utilized in process applications (evaporative processes generated in heat transfer applications) that will likewise culminate in the production of a sodium rich solution that can be introduced either into the recycled regenerant solution reservoir or a secondary dedicated regenerant solution reservoir for use in a polishing regeneration step. Accordingly, a wide variety architectural arrangements can be made to facilitate water and salt conservation as part of the water softening process. Along these lines, it will be readily understood and known by those skilled in the art how to arrange the proper valves and equipment to achieve the objectives of the present invention. Along these lines, it is contemplated that commercially available manifold and control valves, such as those produced by Fleck Controls, Inc. of Brookfield, Wis., could be readily utilized in the practice of the present invention.

Along these lines, and consistent with conventional practices, a backwash application may optionally be provided. Generally, a backwash cycle is not necessary; however, if the water in a particular area is high in suspended solids, such a cycle may be desirable. Such cycle includes moving city water through the resin vessel in a countercurrent direction. This step will reorient the resin bed, allowing better movement of water through the resin bed during the service cycle so as to minimize blockage by suspended solids in the water. Another method embodiment and application of this backwash step is to use regenerant solution, such as the recycled/recovered regenerant, to reorient the resin bed, and thereby concurrently provide removal of hardness ions from the resin (regeneration) while conserving the service water that would normally be wasted during this step.

Additional modifications and improvements of the present invention may also be apparent to those of ordinary skill in the art. For example, the step of contacting the ion-exchange resin with the regenerant solution may include first contacting the ion-exchange resin with the selected volume of the regenerant solution thereby to displace the selected volume of water from the resin vessel, and passing the selected volume of water to a water drain, or by transporting, such as by pumping, the regenerant solution from a brine regenerant reservoir into the resin vessel, and may include contacting the ion-exchange resin with between 0.25 and 2.0 bed volumes of the brine regenerant solution. The step of collecting the waste solution may include transporting the waste solution to an alternative disposal option. Alternatively, the step of contacting the ion-exchange resin with the regenerant solution may include transporting, such as by pumping, a recycled/recovered regenerant solution from the regenerant reservoir (which is derived from the softened water heat transfer application) into the resin vessel, and may include contacting the ion-exchange resin with between 1.0 and 8.0 bed volumes of the recycled/recovered regenerant solution. The step of collecting the waste solution may include transporting the waste solution to an alternative disposal option. The step of contacting the ion-exchange resin with the regenerant solution may further include transporting, such as by pumping and/or educting, a blend of the brine regenerant solution from the brine regenerant reservoir with the recycled/recovered regenerant solution derived from the softened water heat transfer application reservoir into the resin vessel, and may include contacting the ion-exchange resin with between 0.5 and 10.0 bed volumes of the blend of recycled/recovered regenerant and brine regenerant solutions. The step of collecting the waste solution may include transporting the waste solution to an alternative disposal option. The step of contacting the ion-exchange resin with the regenerant solution may additionally include transporting, such as by pumping and/or educting, any, each or all of the afore mentioned regenerant contacting steps from the specified regenerant sources into the resin vessel, and may include contacting the ion-exchange resin with between 0.25 and 10.0 bed volumes of the combination of regenerant solutions. The step of collecting the waste solution may include transporting the waste solution to an alternative disposal option. Thus, the particular combination of parts and steps described and illustrated herein is intended to represent only certain embodiments of the present invention, and is not intended to serve as limitations of alternative devices and methods within the spirit and scope of the invention. Thus, the particular combination of parts and steps described and illustrated herein is intended to represent only certain embodiments of the present invention, and is not intended to serve as limitations of alternative devices and methods within the spirit and scope of the invention.

1. A water softening system, comprising:
(a) a water source that provides water containing undesired ions;
(b) a primary water softening apparatus for receiving water from the water source;
(c) a secondary water softening apparatus for receiving water from the primary water softening apparatus;
(d) an evaporative equipment application selected from the group consisting of a cooling tower and a boiler, the application receiving water from the primary and secondary softening apparatuses;
(e) a regenerant reservoir for holding a regenerant solution produced by the application process, the solution containing sodium ions; and
(f) wherein the regenerant reservoir is in fluid communication with the primary water softening apparatus and operative to transfer the regenerant solution thereto for displacing undesired ions with sodium ions.

2. A water softening system according to claim 1 wherein the undesired ions are calcium and magnesium ions.

3. (canceled)

4. (canceled)

5. A method for softening water that contains undesired ions, comprising:
(a) providing an ion-exchange resin in a resin vessel sized and adapted to receive a fluid, wherein said ion-exchange resin is capable of chemically shifting between an active state operative to exchange sodium ions therein for the undesired ions contained in the water when in contact therewith and an exhausted state operative to exchange the undesired ions therein for the sodium ions contained in a regenerant solution when in contact therewith;
(b) contacting said ion-exchange resin with the water that contains the undesired ions when said ion-exchange resin is shifted toward the active state, thereby to remove the undesired ions from the water and shift said ion-exchange resin toward the exhausted state;
(c) transferring the water produced in step (b) to normal service flow and soft water consumption by an evaporative equipment application selected from the group consisting of a cooling tower and a boiler, the application operative to generate a recycled regenerant solution containing sodium ions;
(d) contacting said ion-exchange resin with the recycled regenerant solution containing the sodium ions produced in step (c) when said ion-exchange resin is shifted toward the exhausted state, thereby to remove the sodium ions from the regenerant solution so as to shift said ion-exchange resin toward the active state;
(e) forming a waste solution containing the undesired ions derived from the ion-exchange resin existing in the exhausted state in step (d); and
(f) displacing a selected volume of water in said resin vessel with said regenerate solution and passing the selected volume of water to a water drain.

6. (canceled)

7. A method according to claim 5 further comprising the step:
(a) providing a source of brine regenerant solution and contacting said brine regenerant solution with said ion-exchange resin following step (d) to displace the recycled regenerant solution.

8. A method according to claim 7 wherein the step of contacting said ion-exchange resin with the brine regenerant solution includes contacting said ion-exchange resin with between 0.25 and 2.0 bed volumes of the brine regenerant solution.

9. A method according to claim 5 wherein the step of contacting said ion-exchange resin with the regenerant solution includes transporting the regenerant solution from a regenerant reservoir into said resin vessel.

10. A method according to claim 9 wherein the regenerant solution is transported by pumping the regenerant solution from the regenerant reservoir into said resin vessel.

11. (canceled)

12. (canceled)

13. A method according to claim 5 wherein the step of contacting said ion-exchange resin with the regenerant solution includes contacting said ion-exchange resin with between 1.0 and 8.0 bed volumes of the recycled regenerant solution.

14. A method according to claim 5 further comprising the steps:
(a) providing a source of brine regenerant solution; and
(b) contacting said ion-exchange resin with a blend of the brine regenerant solution and the recycled regenerant solution.

15. A method according to claim 14 wherein the step of contacting said ion-exchange resin with a blend of the brine regenerant solution and the recycled regenerant solution includes contacting said ion-exchange resin with between 0.5 and 10.0 bed volumes of the blend of brine regenerant and recycled regenerant solutions.
